(19) United States
(12) Patent Application Publication
(10) Pub. No.: US 2023/0016346 A1
(43) Pub. Date: Jan. 19, 2023

(54) BATTERY STORAGE SYSTEM

(71) Applicants: Thomas Haring, Stuttgart (DE); RIVA GmbH Engineering, Backnang (DE)

(72) Inventors: Thomas Haring, Stuttgart (DE); Jochen Mast, Oftersheim (DE); Jean Schutz, Neulubheim (DE)

(21) Appl. No.: 17/816,236

(22) Filed: Jul. 29, 2022

Related U.S. Application Data
(63) Continuation of application No. 16/977,947, filed on Sep. 3, 2020, now abandoned.

(30) Foreign Application Priority Data
Mar. 3, 2018 (DE) 102018001655.3
Mar. 3, 2018 (DE) 102018001983.8
Mar. 4, 2018 (DE) 102018001665.0

(51) Int. Cl. H02J 50/10; H01M 50/204; H01M 10/42; H01M 10/44; H01M 10/46; H02J 7/00; H02J 7/02; H02J 50/00

(52) U.S. Cl. CPC H02J 50/10; H01M 50/204; H01M 10/425; H01M 10/441; H01M 10/46; H02J 7/0013; H02J 7/02; H02J 50/005; H02J 7/0018; H02J 7/0042; H01M 2010/4271; H01M 2010/4278; H02J 2300/30

(57) ABSTRACT

A battery system includes a battery receiving device and a plurality of battery units. Each battery unit can be coupled bidirectionally and inductively to one another and/or to the receiving device for charging/discharging. The receiving device can be connected to an external electrical energy source and/or sink. Each battery unit includes a coil unit. The receiving device has a storage seat for each battery unit removable with a magnetically complementary connectable coil unit for inserting/removing a battery unit without tools. The coil unit has a single coil which is substantially shaped as an elliptical, elongated flat coil, arranged in a half-shell housing and embedded in a ferrite core half-shell of ferrite elements, with a coil unit ratio of thickness to length/width of at least 1:5. The coil unit of the battery unit and receiving device are formed mechanically separable with a maximum distance between the coil units of 110 mm.

### CROSS-REFERENCE TO RELATED APPLICATIONS

This application is a continuation application of U.S. patent application Ser. No. 16/977,947 (Attorney Docket No. RIVA0001PA) filed Sep. 3, 2020, which is a U.S. national stage of PCT/DE2019/000055 filed Mar. 4, 2019, which claims priority of German patent application 102018001655.3 filed Mar. 3, 2018, German patent application 102018001665.0 filed Mar. 4, 2018 and German patent application 102018001983.8 filed Mar. 13, 2018 all of which are hereby incorporated by reference in their entirety.

### FIELD OF THE INVENTION

The invention relates to a battery storage system comprising a battery receiving device and one or more battery units with bidirectional inductive coupling of the individual battery units with one another and/or with the battery receiving device with simultaneous mechanical separation and tool-free interchangeability of the battery units.

### BACKGROUND OF THE INVENTION

From the prior art, battery stores, both in individual cells, as well as connected in parallel and in series, are sufficiently known to the person skilled in the art. The term battery should also be understood as battery storage with secondary cells, in particular accumulators as a rechargeable storage device for electrical energy on an electrochemical basis.

In order to achieve higher voltages, individual cells are connected in series until a voltage between 14 volts and 60 volts is reached. All known electrochemical secondary elements such as lithium-ion batteries, lead batteries, nickel-metal-hydride batteries, metal-air batteries and redox flow batteries can be used as battery cells. In a particular embodiment of the present invention, fuel cell plug-in units and plug-in units for primary batteries can also be used. Primary batteries are e.g. metal-air batteries, zinc-carbon batteries.

In order to achieve higher currents, batteries are connected in parallel. In the example of lithium-ion batteries, individual cells are connected both in parallel and in series. An example of lithium-ion batteries is the connection of 14 round cell packs and 6 cells each in parallel. Another example is the interconnection of rectangular flat cells.

For the use of battery storage systems in mains operation or in mains backup operation for the range of 230 volts or 400 volts or 480 volts (three-phase current), it is necessary to convert the direct voltage and direct current (DC) of the battery (DC (I)) into an alternating voltage and alternating current (AC) and then raise it to the required level using a transformer. This is done via a DC(1)-AC(1)-AC(2)-inverter. Depending on the output voltage, a DC(2)-raise up stage is also used. Then it is a DC(1)-DC(2)-AC(1)-AC(2) inverter or rectifier with additional adjustment to the useful current and voltage, which are usually galvanically connected to one another. In order to be able to recharge the battery at the same time, a bidirectional use of the power electronics is desirable. Everything described up to this point is state of the art and is available on the market in a large number of products.

The disadvantage of the prior art is that it is complicated to handle when charging and discharging the batteries. Electrical contact points must be connected and disconnected through galvanic connections between the batteries and charging and discharging stations, with the risk of incorrect operation/short circuits and mechanical damage on the one hand, and a risk to operational safety and the persons involved on the other.

The object of the present invention is to propose a battery system that enables simplified, error-minimized handling with high operational reliability for charging and discharging battery units for a large number of applications.

This object is achieved by a battery system as described herein. Advantageous embodiments of the invention are also described.

### SUMMARY OF THE INVENTION

According to the invention, a battery receiving device and one or more battery units are proposed, wherein the battery unit can be coupled bidirectionally inductively to one another and/or to the battery receiving device for charging and discharging. The battery receiving device can be connected to an external electrical energy source and/or energy sink. Each battery unit comprises a coil unit and the battery receiving device comprises a storage seat for each removable battery unit with a magnetically complementary coupled coil unit for inserting and removing a battery unit toolless.

In other words, a battery storage system is described in which an AC(1)-AC(2)-upgrade as described above is distributed over two spatially separated units, the battery unit and the battery receiving device. As a result, the total capacity of the total storage of the battery system can now be separated into individual packing units of the battery units in a galvanically isolated manner.

In the following, the term battery unit is intended to mean the battery cells with additional electronics and a coil unit in an essentially encapsulated housing. The term battery receiving device stands for a housing or a cabinet with storage seats and complementary coil units that hold individual battery units. The battery receiving device contains at least one or more receiving coil units AC(2) and subsequent power electronics.

According to the invention a contactless connection by induction of the battery units in their housing to the battery receiving device occur. The battery cells and the electronics for the respective packing unit of the battery units are located in a closed, essentially encapsulated and preferably watertight housing, the battery housing, with several individual cells being able to be combined to form a packing unit of the battery units. The battery unit may include a battery management system (BMS), communication interfaces, fuses, a rectifier, a chopper/inverter, and a coil winding [DC(1)-DC(2)-AC(2)] referred to as a coil unit and corresponds to one half of a transformer, which can preferably have a turns ratio of 10-30. In addition, further electronics such as a temperature measurement sensor, a voltage sensor and a data storage unit can be included in the battery unit.

The great advantage of this design is that the battery unit in its housing can be removed and exchanged during operation, safely and without electrical technical knowledge (“hot-swappable”).

In an advantageous embodiment, the coil unit of the battery unit and the coil unit of the battery receiving device can be mechanically separated with a maximum distance between the AC-AC coil of 110 mm, preferably 100 mm, particularly preferably 10 mm and in particular 1 mm. The distance can be provided by at least one coil coupling plate, preferably a thin coil coupling plate covering a coil or coil arrangement of the coil unit, which is arranged at the battery-side and preferably designed at the same time as a side wall of a housing of the battery unit. The coil coupling plate can advantageously have segmented ferromagnetic partial areas which are formed on contact surfaces of a ferrite core half-shell of the coil arrangement so that an essentially continuous magnetic field closure of the ferrite core half-shells of opposing coil units can be achieved.

In an advantageous embodiment, at least one coil unit comprises a single coil, which is essentially shaped as an elliptical elongated flat coil, wherein preferably a coil winding consists of a high-frequency braid and the coil unit is optimized in terms of its mechanical dimensions and electromagnetic parameters for a frequency range of 50-100 kHz, in particular for an operating frequency of 70 kHz. The coil is preferably arranged in a half-shell housing, in particular made of aluminum, and is embedded in a ferrite core half-shell made of segmented ferrite elements, so that the coil unit has a thickness to length/width ratio of at least 1:5, preferably 1:8, in particular 1:10 or higher. In this respect, a particularly thin, two-dimensionally extended coil unit is constructed, which is ideally suited as a cover for a side surface of a battery unit with a small overall depth. Due to the simple structure within a half-shell, both the coil and the ferrite core half-shell can be constructed in a modular manner and simply assembled by machine. A receiving area for sensor electronics of an NFC unit, in particular Bluetooth or RFID, can also be provided in the half-shell housing, and the coil units of the battery unit and the battery receiving device can be constructed in an identical complementary manner. In particular, the coil unit is constructed mirror-symmetrically with respect to its longitudinal axis, so that it can be used as identical parts in the battery unit and battery receiving device. In this respect, on the battery unit side, the coil unit with NFC unit and induction coil contains all connection and communication elements with respect to the outside world that can be contacted via a single housing side, preferably the smallest housing side in terms of area, the front side of a usually cuboid housing.

In an advantageous embodiment, several battery units accommodated in a battery receiving device can provide a total electrical capacity of 1.5 kWh to 1700 kWh.

In an advantageous embodiment, at least two or more battery systems can be connected to two or more battery systems to form a larger system complex.

In an advantageous embodiment, the battery unit and/or each storage seat can be comprised of a mechanical and/or a magnetic locking unit for releasable locking a replaceable battery unit. The locking unit enables insertion of the battery unit into the storage seat in the correct position and/or prevents unintentional removal of the battery unit, preferably in a charging and/or discharging phase. A mechanical locking unit can include, for example, mechanical locking structures in the housing shape of the battery unit and/or in the insertion opening of the storage seat to prevent incorrect position orientation when inserting the battery unit, and also a pull-out lock that can be activated by an actuating element can prevent unintentional pulling out of the storage seat, so that after locking the Battery unit in the storage seat an exact alignment of the coil units to one another is guaranteed. Alternatively or additionally, for example, a DC magnet coil on the storage seat can attract a ferromagnetic yoke element arranged inside the housing of the battery unit at least when charging or discharging the battery unit with a predefined power value, in order to prevent the battery unit from being removed in a force-locking manner, until an energy transfer is ended electronically regulated. Furthermore, it is advantageously conceivable that, in the event of a fault detection, a motor-driven ejection factor, or a magnetic coil arrangement based on the principle of repelling magnetic fields, can be provided as an ejection factor in the storage seat and/or battery unit, which, when a fault or warning is detected by the battery unit or the battery receiving device, e.g. from excessive current load, unusual temperature or pressure increase or the like, or e.g. in the event of incompatible data communication or unpaid energy costs, automatically (partially) ejected from the storage facility.

The battery receiving device and/or the battery unit advantageously detects the amount of electrical energy consumed or output in the form of a Coulomb counting. A coulomb stored by a battery unit as an ampere second is an amount of charge that can be picked up or released by a battery unit and can be determined, for example, by measuring time-based charging and discharging currents. The measurement of the total amount of charge taken up and released provides—based on a reference value—indirect information about the charge status of a battery unit, wherein the condition and quality of the battery unit over its lifetime can be recorded with chronological recording. The Coulomb counting can advantageously be recorded chronologically, for example, in a block chain-like data structure within the battery unit or in a cloud storage device and stored centrally in a cloud storage device via the battery storage device, for example, in order to obtain an analysis of the behavior of all identical battery units and, for example, to change a charge and discharge behavior with increasing age or to provide an exchange or changed use of the battery unit. A tariffing and monetary evaluation of the use of the battery unit can be carried out on the basis of Coulomb counting.

A battery management system of the battery unit advantageously provides active balancing of the cell charge. To increase the nominal voltage, battery packs usually consist of several individual cells or cell blocks connected in series, whereby in practice cells are charged and discharged differently. There are several different methods of balancing, i.e. a balance of the amount of charge between the cells, which are referred as passive and active balancing. With passive balancing, cells that have already reached the end-of-charge voltage are connected by a balancing circuit to an additional resistor in parallel with the cell, whereby the voltage of this cell is limited to the end-of-charge voltage. This cell is then only slightly further charged or even slightly discharged, while the cells in the series connection which have not yet reached the end-of-charge voltage continue to be supplied with the full charging current. In active balancers, the balancer circuit realizes a charge transfer between neighboring cells and transfers the energy from cells with a higher charge to cells with a lower charge. The advantage of active balancing is the significantly higher degree of efficiency, since excess energy is only converted to a small degree into heat, so that the battery unit maintains a longer service life and high capacity over the period of use.

In an advantageous embodiment, the battery receiving device can comprise at least one storage seat, preferably two or more storage seats with at least one magnetically complementary connectable coil unit, preferably one coil unit per storage seat for inserting and removing a battery unit without tools. The storage seat can have a typical 19 inch-locking dimension so that, in particular in the case of a battery receiving device with a large number of storage seat, it is possible to fall back on industry-standard designs for a rack for electrical devices with a standardized width of 19 inches, in which the individual devices (slide-in units ″) that can be mounted in the rack have a front panel width of exactly 48.26 centimeters (=19″) (e.g.: subracks). A height unit is specified as 1.75 inches (=4.445 cm), a division unit (TE) for the module width within a slot with ⅕ inch (=5.08 mm), so that the maximum size of a battery unit adapted for this is given. Such a 19-inch rack system is standardized for industry-wide compatibility (EIA 310-D, IEC 60297 and DIN 41494 SC48D) and offers a modular system for providing a farm of battery units. Furthermore, a pressing unit, in particular a spring element, can preferably be arranged in the storage seat for exerting a spring-loaded pressing force on the battery unit in the inserted state in the direction of the coil unit. The spring element can be designed, for example, as a curved sliding plate. Thus, when the battery unit is pushed into the storage seat, it is ensured that the coil units are closely opposite one another. After the battery unit has been pushed into the storage seat, the pressing unit can also be provided by a mechanical wedging effect of an actuating mechanism, for example by means of a door mechanism.

Each storage unit of the battery receiving device advantageously comprises an NFC unit, which communicates in 1:1 communication with the battery unit that is received. It is also conceivable that a single NFC unit communicates with a plurality of battery units. A 1:1 relationship of coil units and NFC units per storage unit can thus advantageously be provided, but also a 1:X relationship of the coil unit and NFC unit of the battery receiving device with a plurality of battery units.

Furthermore, each battery receiving device advantageously comprises a higher-level battery management system that can communicate with each battery unit via the NFC interface and control the charging and discharging process of the battery units, and can initially read out operationally relevant parameters of the battery units. In particular, internal communication can take place via an EMC-resistant, robust RS-485 data bus. The battery management system on the storage seat side is advantageously connected to the Internet via an Internet gateway in order to exchange data with a central data memory, in particular a cloud application, and to enable networked data monitoring of the battery units. This also enables a universal billing system and the life cycle of each battery unit can be predicted. Thus, a two-stage battery management system is provided, each battery unit comprising an individual battery management system that can be monitored, controlled and, if necessary, supplied with updates by the higher-level battery management system of the battery receiving device.

In a further advantageous embodiment of the battery receiving device, the aforementioned superordinate battery management system has an intermediate circuit with a DC intermediate circuit voltage of 400V to 800V. At this level of the intermediate circuit voltage, DC high-voltage energy can be fed in or released directly, so that, for example, photovoltaic cells can feed in high-voltage directly or vehicles can draw high-voltage voltage directly for charging or operating the on-board network. In this respect, such a battery receiving device can also provide directly for the delivery of energy for charging electric vehicles in the high-voltage range. The battery management system also links the internal DC intermediate circuit with an AC power supply or provides the same, wherein preferably bidirectionally working converters or inverters being used for the conversion. The converter also works as a stand-alone inverter and can operate both high inductive and capacitive loads and can be exposed to non-sinusoidal, harmonic current loads. A multi-stage, in particular 3-, 5- or 7-stage structure of the half-bridges of the converter is particularly advantageous, so that a reduced harmonic content of an provided AC output voltage or energy fed in can be achieved, preferably a high capacitive DC link capacity is provided for smoothing and buffering any overvoltage that may occur. In this way, even in the event of failure or unexpected disconnection or insertion of battery units, the battery receiving device can remain functional without interruption.

The battery holding device also advantageously comprises an active temperature control device which provides a heating and/or cooling function. Battery cells suffer from a loss of capacity or are at risk from overheating, particularly in particularly warm or cool environments. At least in the received state, the battery receiving device can maintain an optimized temperature level for long-lasting operation of the battery units.

In an advantageous embodiment, the battery unit can be encapsulated in a battery housing and at least one, in particular a plurality of battery cells, a coil unit, a battery management system and an NFC unit can be included. In this embodiment, it is essential in particular to include at least one NFC unit (near field communication unit). This can provide an at least mono-directional data connection from the battery unit to the storage seat, preferably a bidirectional data connection based on WiFi, Bluetooth, RFID or other NFC standards and/or infrared interface units. NFC is an international transmission standard based on RFID technology for the contactless exchange of data by electromagnetic induction by means of loosely coupled coils over short distances of a few centimeters and a data transmission rate of a maximum of 424 kBit/s, however, in context of the invention a WLAN or other Short range radio communication or IR communication can be used by the NFC unit. The purpose of the NFC unit is to transmit and to record operating data and parameters, such as type specification, unambiguous addressing of the battery unit, a history of voltages, currents, temperatures, charge states, error messages and logs, operating hours counters and memories in which data from the memory unit are stored to be read out or transmitted later. This transmission takes place separately and independently of the inductive energy transmission. As a result, operating data and the status of the battery unit can also be read out using a mobile terminal device such as a smartphone, smartwatch, tablet computer or the like, without activating the coil unit for this purpose. For this purpose, signals can also be transmitted when the battery unit is in de-energized stand-by mode, for example using an app on a mobile device. In this way, an app on a mobile terminal device can be used to read out operationally relevant data from the battery unit even when the battery unit is deactivated and removed by approaching and placing the terminal device on the side of the coil unit, so that simple monitoring and battery maintenance of the battery units is made possible. The NFC unit is particularly advantageously arranged in a housing of a coil unit for inductive energy transmission, so that a compact structural unit and a spatially close positioning of both the induction coil of the split transformer arrangement and the opposing, communicating NFC units of the battery unit and battery receiving device can be achieved. In the de-energized state, an NFC unit can be activated passively by means of the slight energy input of the transmitter coil of the reading device or the storage seat by bringing it close to a reader, e.g. a smartphone or by inserting it into a storage seat, and wake the battery management system out of a deep sleep phase. A very long storage and standby time can thus be achieved without energy being consumed by internal signal communication and constant monitoring.

The battery management system of the battery unit can advantageously provide a cell protection function by the aforementioned cell balancing, provide data communication with the battery receiving device, control the DC/DC converter for the charge-discharge operation and control the coil inverter for the bidirectional inductive exchange of energy.

In a particularly advantageous manner, the coil unit and the NFC unit can be structurally integrated in a front side of the battery housing which is smaller regarding the areas of other side surfaces of the battery housing. A close connection between the induction coil and the wireless data interface can thus be achieved. A pressing unit, in particular a spring element, is preferably arranged on a surface opposite this front side for applying a spring-loaded pressing force in the insertion state in a storage seat on this front side. The spring element can be designed, for example, as a curved sliding plate. Thus, when the battery unit is pushed into the storage seat, it is ensured that the coil units are closely opposite to one another. After the battery unit has been pushed into the storage seat, the pressing unit can provide or release a pressing force by means of a mechanically adjustable wedging effect of an actuating mechanism.

In one embodiment, a battery storage device with a total capacity of 10 kWh can be considered. The battery storage device can comprise several, preferably six, lithium iron phosphate flat cells, for example, each with 500 Wh-capacity, which are connected in series. This enables an end-of-charge voltage of 21 volts and a nominal voltage of 19.2 volts to be achieved. Battery cells made from lithium iron phosphate flat cells have the advantage of robust behavior and intrinsic security against explosion, so that this type of cell is suitable for rough handling and extreme temperature conditions. The voltage can be increased to 40 to 48 volts of a battery-side intermediate circuit using a DC-DC boost stage. This is followed by an electronic chopper unit as a two or more-stage inverter or rectifier-inverter unit with a coil connected to the battery-side coil unit. This battery unit can be encapsulated in a single housing. The receiving-side coil unit of the battery receiving device can be arranged in a housing of the battery receiving device, for example in a cabinet on a side wall, rear wall or in the slide-in base or in the slide-in cover.

In the present example, an arrangement of the receiving-side coil unit in a side wall is envisaged. An alternating current can be induced in the receiving-side coil unit from the PWM-modulated alternating magnetic field generated by the battery-side coil unit.

The receiving-side coil unit as a receiver coil can optionally be constructed in such a way that in each case a single coil of the battery-side coil unit is opposite or extends over several battery-side coil units.

The alternating current of the coil units is controlled by power electronics, preferably via PWM-based control of a chopper, i.e. Inverter adjusted in voltage and current strength by an inductively usable magnetic alternating field. The adjustment of the current intensity and frequency of the coil current by the inverter is adapted to an electromagnetic configuration of the coil unit so that the highest possible efficiency of the energy transfer between the coil units can be achieved with low leakage losses.

In an advantageous embodiment, the battery unit can be mechanically closed without having any switches or openings to the outside, and can only be charged and discharged via induction. The advantage of this arrangement of a battery unit that is inductively and galvanically decoupled via the housing is that no switches or contacts have to be installed in the battery unit, and that the battery unit can be safely removed and also inserted during operation. This allows a charged or discharged battery unit to be exchanged from one location to another. For example, a battery unit can be charged in the house (ceIIar) and, if necessary, used as additional storage in a mobile application (electro mobility).

The electronics of the battery unit can comprise a battery management system. For this purpose, the battery housing is constructed in such a way that energy flows from or into the battery unit only after a previously positive data communication between the battery receiving device and the battery unit. The communication can be part of the battery management system and can take place in a conventional protocol that is expanded to include the component of AC(1)-AC(2) separation.

The battery unit can advantageously be charged with just one transformer coil as a coil unit at one location A, transported to another location B and discharged there again.

The inductively separated battery units allow a variety of plug-and-play variants. Energy storage can be charged and directly removed, i.e. without having to loosen the plug, and fed to an electrical consumer that has the counter coil. The possible applications are diverse, e.g. a use of the battery unit for all types of craftsmen's devices, especially in the commercial sector, gardening tools, lawn mowers, welding devices for commercial use, induction cookers, emergency power devices of all kinds, to name just a few. According to the data communication via NFC communication, which is independent of the energy generation, not only status information but also billing information, e.g. be provided for rental battery units or a quota of electrical energy, can be provided. Billing data can be exchanged each time a battery unit is introduced into a battery receiving device and offset in a billing account of the user. The user can log in and out using NFC communication between a mobile data device of the user such as a smartphone, smartwatch or the like and a battery unit.

The battery unit can be adapted to the respective consumer. The inductive coupling of the charging unit and also of the discharging unit with the individual battery unit is decisive for the present invention.

For the use of the charged battery units in applications with the highest possible power-to-weight ratio, e.g. in welding machines and in the case of lawnmowers, lithium polymer battery cells can advantageously be used.

Another advantage of the inductively separated battery units in the cabinet described above or the battery receiving device of several battery units is the possibility of receiving different types of batteries next to one another or at the same time. These can be lithium polymer battery cells or lithium iron phosphate battery cells. But also lead battery cells or nickel metal hybrid battery cells. There is no restriction on the choice of battery cells that can be used. In practice a few types of battery cells will be referred to e.g. different lithium types.

A large number of battery units can be loaded in containers or shelf arrangements and removed safely if necessary.

Different power ranges are conceivable, for example as Power to go (mobile)=4 kWh or 6 kWh, as Power Rack (domestic use)=12 kWh or 20 kWh and as Power MRack=1.7 MWh.

The individual battery units can be taken from a 20 kWh or a 1.7 MWh system during operation and e.g. fed to a 4 kWh system.

This is particularly advantageous when using mobile traction, i.e. in electric vehicles. The safe handling allows a non-specialist to exchange battery units with induction technology.

In one embodiment of a battery unit, in addition to the pure power electronics of the battery management system, microcontrollers, voltage monitoring, temperature monitoring, electronic clock, WLAN module and/or Bluetooth or another radio communication module can be installed. In addition, fuses and memories for logging, and optionally active or passive RFID chips can be provided in the battery module. In this case, a coil frequency can preferably be regulated in an optimized manner for power transmission using this technology. The present battery unit can carry out all charging and discharging processes with time stamp and temperature, for example in a block chain data structure in a tamper-proof manner and this information can be passed on to a central information storage and processing device, for example a cloud storage device or internet-based power management and control system. A predictive exchange and remote maintenance of the battery units is also possible. The network access can take place via the NFC data interface of the battery unit with the battery receiving device, the battery receiving device being connected to the information storage and processing device wirelessly or by wire.

In one embodiment, specific information of the respective battery unit can be passed on to the electronics in the switch cabinet of the battery receiving device. The storage seat of the battery receiving device which contains the individual modular battery units stores information about the respective battery unit.

If a battery unit is located in a storage seat of a battery receiving device, these can communicate with one another in a master-slave mode, wherein the battery receiving device can be the master. Communication is comparable to a computer to which several hard drives are connected. The hard drives are the inductively coupled battery units.

A major advantage of induction technology using single cells is that the battery units can be used in a corrosive environment or in water. Both the consumer e.g. an electric motor as well as the energy-supplying storage device can be completely encapsulated and have no exposed electrical contacts. This is advantageous in maritime applications and can be used excellently there.

An exemplary embodiment of a battery unit with a coil unit is described below: A number of n battery cells are first connected in series and converted by means of a DC-DC converter from e.g. 12V into a higher intermediate circuit voltage, for example 32V. This voltage is inverted in a further stage into a sinusoidal alternating voltage with a higher frequency. This alternating voltage is connected to the battery-side coil unit. The entire arrangement is encapsulated, in particular with a water-impermeable plastic layer, so that there are no electrical contacts from the outside. The battery unit can thus achieve a degree of protection of IP 65 or more. The energy exchange with the cells or the electronics takes place exclusively via the coil unit, so that no electrical contacts can be found on the battery unit.

A coil unit on the receiving side with the same winding or a coil winding that is adapted to the desired voltage is necessary for this battery unit in order to be able to absorb and output energy. This counter coil is connected to power electronics with a control unit. The control unit adapts the current according to performance or actively. As already described above, the two induction coils can be advantageous spatial separated, at least one being located in a closed housing. In one embodiment, the receiving-side coil unit, which does not contain the batteries, is connected to a consumer, this being an electric motor which itself sets in motion via an induction mechanism. The result is a battery system that consists of several components, all of which are completely galvanically separated from each other. In this combination and especially in those presented here with sizes from 100 Wh up to 10 kWh as a self-contained storage unit, such battery systems can be used in a versatile and reliable manner.

A particular application is the use of the battery unit in a liquid environment, in particular in an aqueous environment. The only boundary condition that emerges and is self-evident to the person skilled in the art is the use of insoluble housing materials in relation to the immersed solution.

The battery unit can be stored e.g. in the sea, a lake or another water in the charged state or in the uncharged state and are permanently exposed to the surrounding water without experiencing damage. In this case, permanent means a period of days to years. Damage is understood as the penetration of water and/or ions in the water. The prerequisite for this is the use of rot-free housing materials, such as fluorinated hydrocarbons, polyethylenes, polypropylenes, PVC types.

One possible application is in the maritime sector. Divers and cave divers can transport and deposit charged battery units to a place in the water and at a later point in time the battery unit is connected to the consumer. The energy is transmitted to the consumer via induction. The consumer's work performance e.g. emitting light, driving a motor, etc. is galvanically separated so that no water can penetrate the entire system when changing batteries or operating.

In one embodiment, the aforementioned battery unit can be used in sewers and similar environments.

A particular embodiment is the use of the battery system with a plurality of battery units in an overall system that contains one or more reluctance motors. The reluctance motors are galvanically separated from their energy supply.

An advantageous application can be the use of the storage units in explosion-protected areas, so-called explosion protection.

In an advantageous further development, a battery receiving device can be designed as an intermediate switching element for connecting a battery unit to another battery unit and/or for charging and/or discharging an individual battery unit, and for this purpose the storage seat only encompasses a partial area of a housing of the battery unit, and preferably two opposing or adjacent storage units are comprised in order to be able to connect at least temporarily and toolless one or two battery units inductively. This type of battery receiving device with a significantly reduced scope of functions does not necessarily require a connection to an external network and can have reduced functional properties compared to stationary battery receiving device. The intermediate switching element can have a limited functionality for the pure extraction of energy from a battery unit e.g. for a 230V AC socket operation, or serve as a charging station for electronic mobile devices with USB port. A direct transfer of energy from a fully charged battery unit to a discharged battery unit can also be provided, so that battery-to-battery charging can also be made possible between battery units of different sizes. This intermediate switching element is relatively small and handy and easy to transport.

### BRIEF DESCRIPTION OF THE DRAWINGS

Further advantages result from the present description of the drawings. Exemplary embodiments of the invention are shown in the drawings. The drawing, the description and the claims contain numerous features in combination. The person skilled in the art will expediently also consider the features individually and combine them into useful further combinations. Thereby show:

FIG. 1 is a schematic circuit diagram of an embodiment of a battery system 10 with two battery units 30 and a battery receiving device 20 according to the invention;

FIGS. 2a to 2g are several detail and sectional views of an embodiment of a battery unit 30 with inductive coupling possibility with a battery receiving device 20;

FIGS. 3a-3c are several partial views of an embodiment of a mobile battery receiving device 20 for receiving one, two or more battery units 30;

FIG. 4 is a view of an embodiment of a container battery system 100 (Power-MRack) for highenergy storage and delivery as well as charging of a large number of battery units 30 and for 16 supplying larger energy consumers or storing energy from larger regenerative energy producers; and

FIG. 5 is a view of an embodiment of a column battery receiving device 110 for a publicly accessible charging and replacement of battery units 30.

### DETAILED DESCRIPTION OF THE INVENTION

In the figures, similar elements are numbered with the same reference numerals. The figures show only examples and are not to be understood as restrictive.

The attached drawings and illustrations contain data from sample designs. All information in the figures is part of this description.

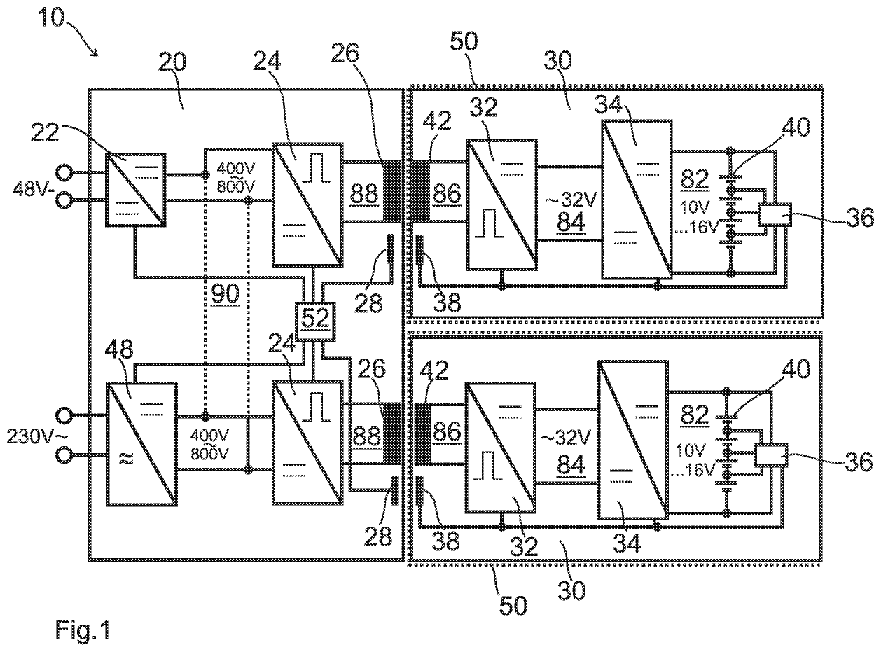

A circuit diagram of a first embodiment of a battery system 10 is shown schematically in FIG. 1. The battery system 10 is composed of a battery receiving device 20 for charging two inductively coupled battery units 30, which are received mechanically guided in storage seats 50 of the battery receiving device 30. Each battery unit 30 includes a plurality of series-connected battery cells 40 which provide a DC voltage of approximately 10V-16V in a battery cell voltage circuit 82. Energy can be exchanged between the battery cell voltage circuit 82 and a battery intermediate circuit 84 via a bidirectional DC/DC converter which has both a step-up and a step-down capability. The battery intermediate circuit 84 can operate with a DC voltage of 32 V, for example. A two- or multi-stage inverter 32 with, in particular, two half bridges can be arranged on the battery intermediate circuit 84 in order to provide an alternating voltage in a battery coil circuit 84 for operating an inductive coil unit 42. By means of a PWM control, the frequency and energy of the alternating current supply in the coil circuit 84 can be adjusted for inductive reception or delivery of electrical energy via the coil unit 42. The coil circuit 84 is preferably operated in a frequency range of approximately 70 kHz, the electromagnetic properties of the coil unit 42 being optimized for this frequency range.

In parallel with the coil unit 2, an NFC unit 38 is arranged, in particular spatially adjacent on a housing wall of the battery unit 30. This can exchange bidirectional data with a corresponding NFC unit 28 of the battery receiving device 20, regardless of the energy transfer state of the coil unit 42. It is thus possible to read in or read out data even when there is no other current in the intermediate circuits 82, 84, 86, so that the battery unit 30 does not suffer any loss of power in stand-by mode and can still be addressed. For this purpose, a small amount of energy input into the NFC unit 38 can be sufficient to provide its communication capability. The NFC unit 38 is advantageously arranged in a common antiferromagnetic housing, for example in an aluminum half-shell housing together with the coil unit 42, which is covered by a coil coupling plate, which represents a wall area on the housing side. The NFC unit 38 is connected to a battery management system 36 which monitors and controls a charging and discharging process of the battery cells 36 as well as provides data for identifying the battery unit 30, the type, state of charge (Coulomb counting), service life and other diverse data preferably via an RS 485 and controls the charging electronics.

The battery receiving device 20 has a separate coil unit 26 in a storage seat 50 for each battery unit 30, and spatially adjacent to it an NFC unit 28 for data exchange, and is controlled by a higher-level battery management system 52 as well as the respective coil units 26 serving inverters 24 and the input and output side DC/DC converter 22 for feeding, for example of energy from fuel cells or photovoltaic systems and converters 48 for feeding in and feeding out alternating or three-phase energy. For this purpose, the bidirectional converter can comprise two inverter units for rectifying or inverting a DC intermediate circuit voltage. The inverters 24 arranged to operate the coil units 26 for each battery unit 30 operate a coil circuit 88 at a frequency that is matched to the battery-side coil circuit 86. The frequency and details of the energy transfer in charging or discharging operation can be negotiated with the battery-side NFC unit 38 via an NFC unit 28 arranged spatially adjacent to the coil unit 26 and can be communicated to the superordinate battery management system 52 of the battery receiving device 30, that determines and controls the required parameters. The battery management system 52 can advantageously establish a gateway interface to the Internet, for example via a GSM-based radio interface, WLAN, Bluetooth or via powerline communication (PowerLAN) in order to be able to access an external cloud application and tariffing. A DC intermediate circuit 90 with a high-voltage voltage level of 400V-800V can be provided within the battery receiving device 20, so that the required voltage of up to 400V for AC power grid operation and for a direct DC feed of PV-voltage up to 800V or supply of DC-battery management system 52 provide high-voltage vehicle electrical systems up to 800V can be provided. In this respect, the split transformer arrangement of the battery-side coil unit 42 and the receiving-side coil unit 88 can advantageously already carry out a voltage transformation in a transmission ratio of 1:10 to 1:20.

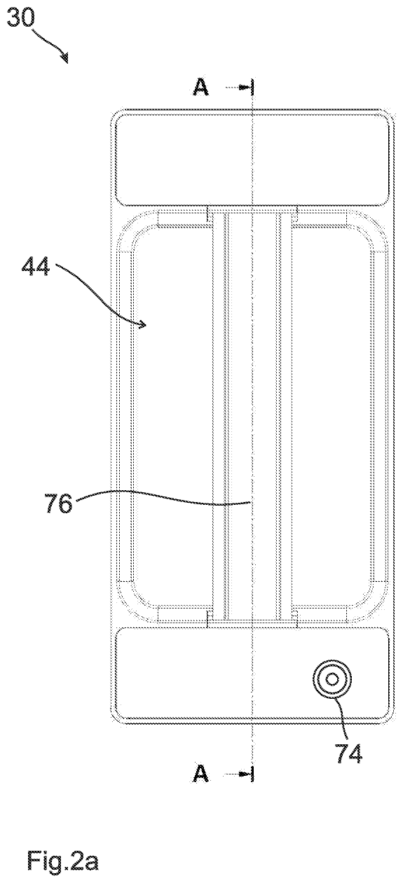

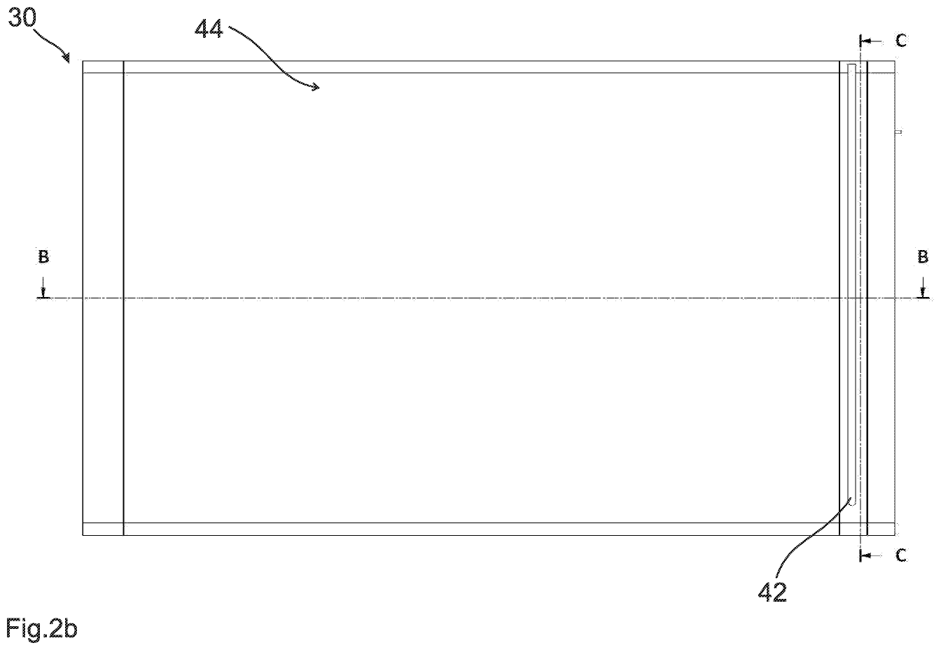

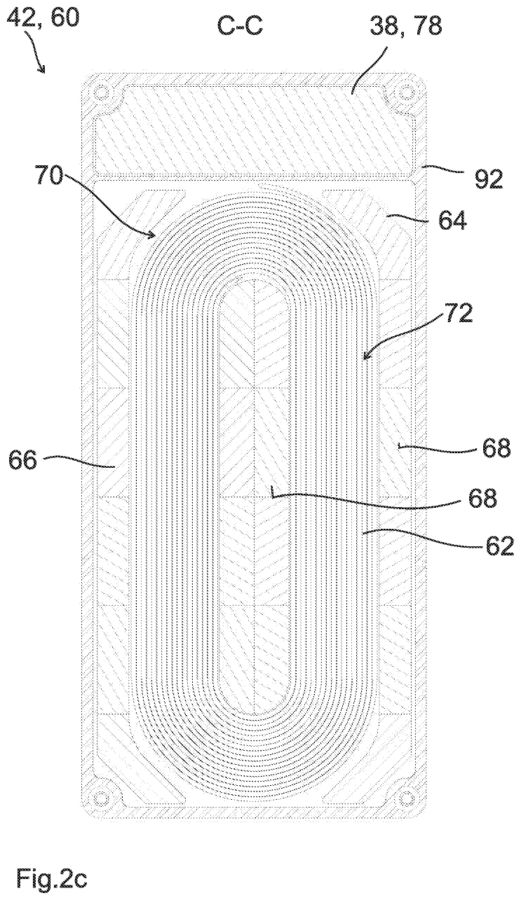

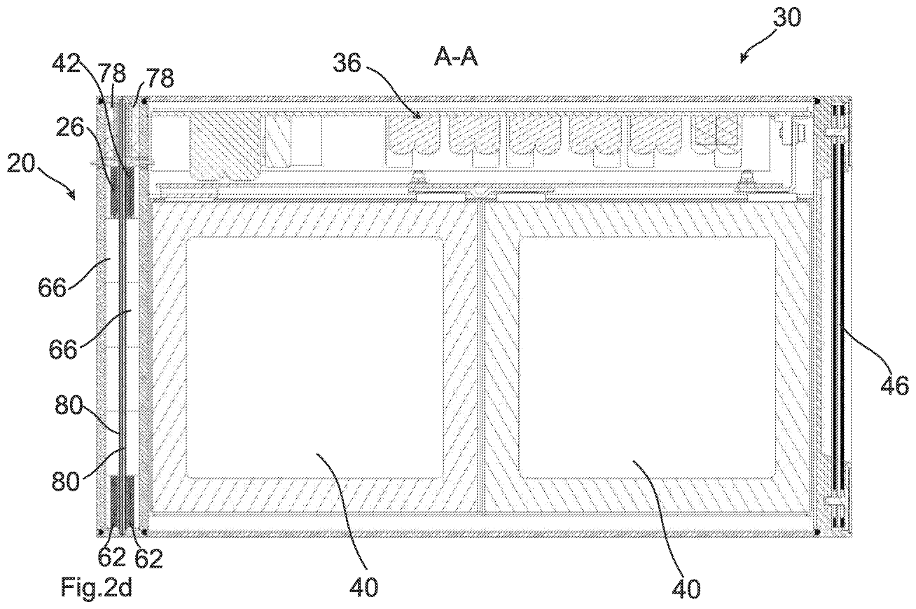

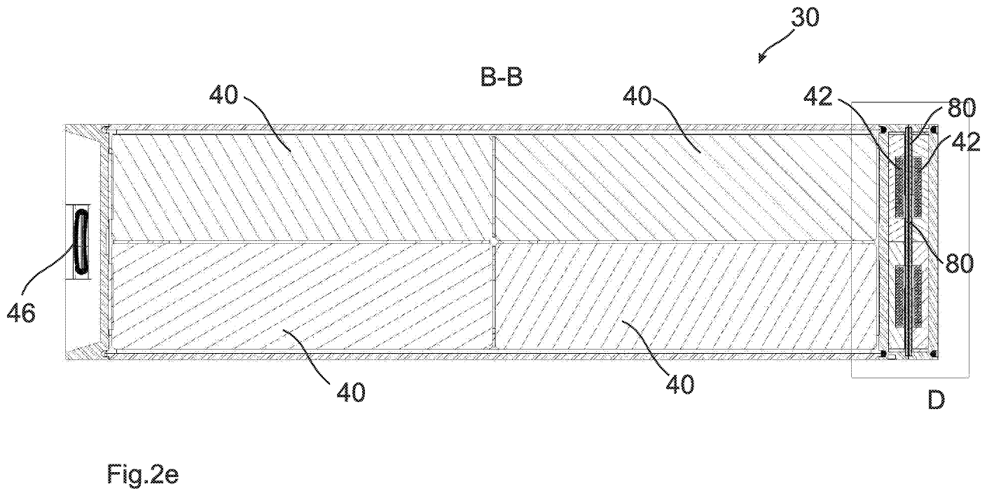

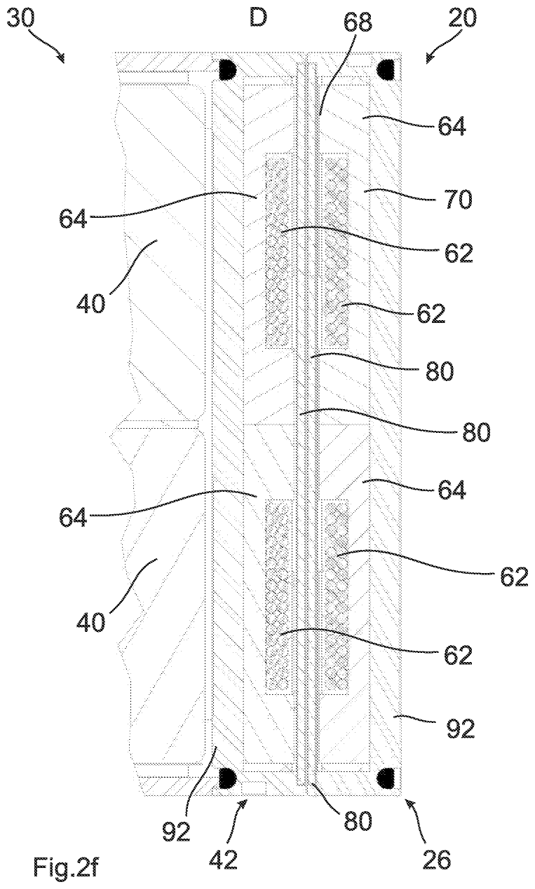

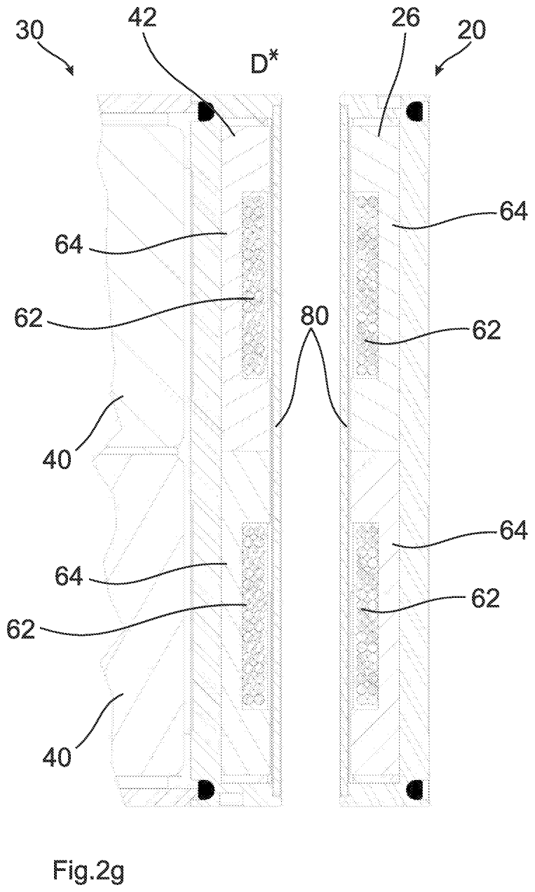

In the sub-FIGS. 2a to 2g, the structural design of an embodiment of a battery unit 30 is described in detail in side and sectional views. For this purpose, FIG. 2a shows a front view and FIG. 2b shows a side view of a housing 44 of a battery unit 30. On an front side, which is opposite a front face having a coil unit 42, a battery handle 76 is provided for carrying, and for sliding in and out the battery unit 30, the housing 44 having a essentially cuboid shape and being completely encapsulated, and essentially comprising a metal jacket. On a side surface opposite the handle side, the coil unit 42 is arranged, which is covered by a coil coupling plate made of plastic, in which preferably segmented ferromagnetic partial areas are provided on contact surface areas, where ferrite yokes of the two coil units 26, 42 face each other in order to maximize the flow the magnetic flux and minimize wastage. NFC data communication via the NFC unit 38 with the battery-side battery management system 36 can also take place through the coil coupling plate 42.

On the handle side, one or more pressure relief valves 74 can be arranged adjacent to the handle 76, so that in the event of a defect in the battery cells 40, excess pressure can escape from the housing 44. The pressure relief valves 74 can be designed in the form of check valves.

In the side view of FIG. 2b, the plane of the coil unit 42 is shown in a side view, in FIGS. 2a and 2b sectional lines of the other FIGS. 2c to 2g are shown.

FIG. 2c shows, in a sectional view C-C of FIG. 2b, the construction of a coil unit 42 in detail, which is structurally and functionally complementary to the coil unit 26 and follows a basic concept of a generalized coil unit 60. The coil unit 60 comprises a non-ferromagnetic half-shell housing as an aluminum half-shell housing 92, which comprises a receiving area 78 for receiving an NFC unit 28, 38 and a coil receiving area. In the coil receiving area there are a large number of platelet-shaped, mutually electrically isolated ferrite elements 66 arranged to form a ferrite core half-shell 64, the ferrite core half-shell 64 has protruding contact surfaces 68 and a recessed return area 70 which forms a shell area 72 for receiving an induction coil 62. The contact surfaces 68 serve to transfer the magnetic flux that forms into corresponding contact surfaces 68 of a complementarily opposite coil unit 60 without scattering losses. The induction coil 62 can be constructed from a substantially elliptical elongated flat coil, wherein the coil line can be constructed, for example, from a twisted high-frequency strand. The entire coil arrangement 70 is optimized in terms of its mechanical dimensions and electromagnetic parameters for a frequency range of 50-10 kHz, in particular for an operating frequency of 70 kHz. High-frequency strands are twisted like a rope from many (isolated) individual wires, so that a skin effect can be counteracted. For this purpose, a twist angle of the high-frequency braid, the radius size and the effective length and width of the flat coil shape and the number of turns can be matched to the desired frequency range. The coil 62 is connected to the coil circuit 86 of the battery unit 30 or to the coil circuit 88 of the battery receiving device 20, the complementary coil arrangements 42, 26 advantageously being able to differ in their winding ratios in such a way that desired voltage levels of the intermediate circuits 84 of the battery unit 30 or the intermediate circuit 90 of the battery receiving device 20 can be provided.

FIG. 2d shows in a sectional illustration A-A a longitudinal side cross section and FIG. 2e shows a transverse side cross section B-B of FIG. 2a through the battery unit 30. It comprises four battery cells 40, which are delimited on an upper side by a circuit board arrangement of the battery management system 36. A spring element 46 is shown on the right-hand side of the sectional illustration in FIG. 2d (in FIG. 2e on the left-hand side). A storage seat 50 of a battery receiving device 20 receives the battery unit 20 in the transverse direction, so that the coil arrangement 42, which is shown on the left in FIG. 2d, rests against a side wall of the storage seat 50 under spring pressure. On this side wall, the coil unit 26 of the battery receiving device 20, which is also shown in FIG. 2d on the left and FIG. 2e, comes into frictional surface contact with the coil unit 42 of the battery unit 30 for minimizing the stray field of a magnetic field exchange coupling.

The battery management system 36 includes power switching elements for charging and discharging, a PWM driver circuit as a chopper or inverter 32 for operating the coil circuit 86 through the inverter 32 and a DC/DC converter 34 for the bidirectional conversion of the 10V-16V battery voltage circuit 82 into the 32V intermediate circuit 84. In addition, the battery management system 36 provides a communication device of the NFC unit 38 for the bidirectional exchange of control and status data, which is supported by a processor and storage system. The exchangeable data via the NFC interface includes a unique identification of the battery unit 30, type information, life cycle information, current charge status, current and voltage levels, a history of the energy status (Coulomb counting) and other data. The NFC interface can be activated passively from a stand-by mode by approaching a reader de-energized, so that the battery unit does not consume any energy in the idle state.

In the further partial representations D and D * of FIGS. 2f and 2g, an inductively coupled state (FIG. 2f) and decoupled state (FIG. 2g) of the coil units 42 and 26 is shown. The coil units 26, 42 are constructed as shown in FIG. 2c and can differ in terms of the winding ratio or can be identical. The opening areas of the half-shell housings 92 accommodating the coil units 26, 42 are separated by thin coil coupling plates 80. The thickness of the thin coil coupling plates 80 and the defined alignment of the ferrite core half-shells 64 to one another determine the leakage losses and the energy transmission efficiency of the inductive coupling. The coil coupling plates 80 can advantageously have ferromagnetic inserts in some areas segmented from one another for guiding magnetic flux between the contact surfaces 68 of the ferrite half-shells 64, which provide the transformer core. FIG. 2f shows an inductively coupled state of the battery unit 30, FIG. 2g an inductively separated state of the battery unit 30 for the storage seat 50 of a battery receiving device 20, as e.g. in the case during an exchange during charging or discharging to provide hot-swap capability.

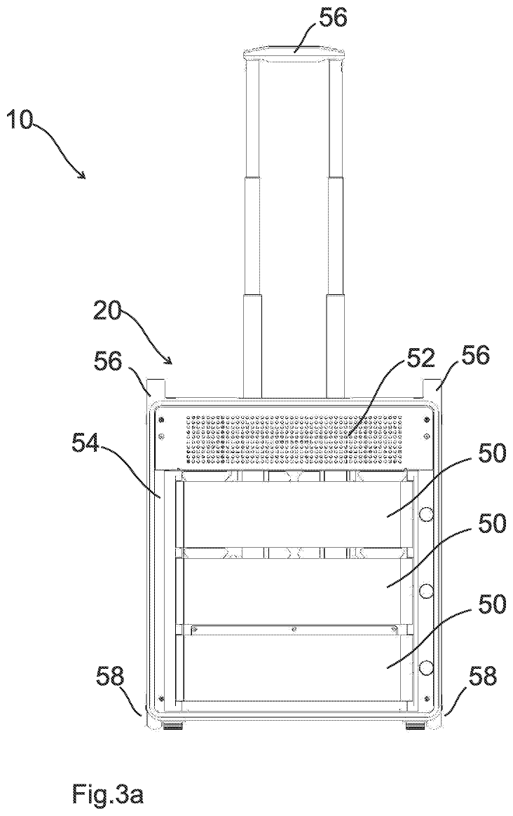

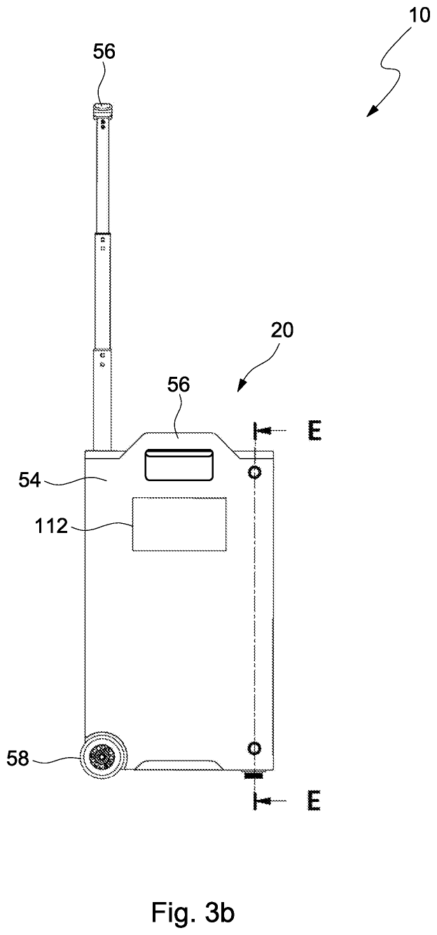

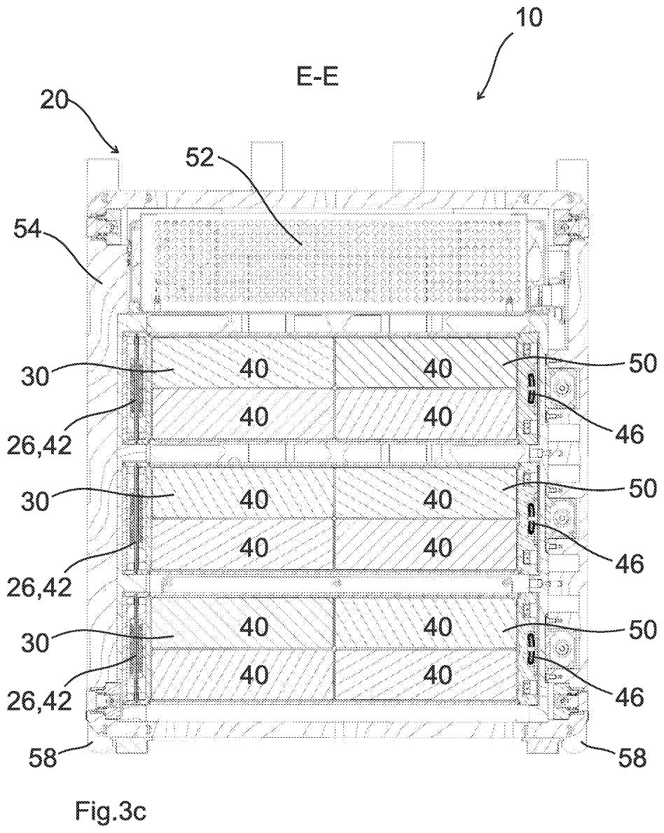

FIGS. 3a, 3b and 3c show a front, side and sectional view E-E through an exemplary embodiment of a battery system 10 with a mobile battery receiving device 20 which can be equipped with three battery units 30. The battery receiving device 20 is equipped with feet and transport rollers 58 in the manner of a trolley case. Carrying handles 56, which can also be extended to form a telescopic handle or lowered into the housing 54, can facilitate the transport of the battery system, which can weigh between 35 to 60 kg when fully equipped. The higher-level battery management system, which is described in detail in FIG. 1, is arranged in the upper region of the housing 54, and the temperature can be controlled with a passive cooling structure or an active cooling system. By opening a cover plate or cover door, three storage seats 50 can be exposed, into which battery units 30, as shown in FIG. 2b, are inserted in a transverse direction, so that their coil unit 42, arranged on a narrow side surface, is in contact with a coil unit 26 of the storage seat 50. In this case, a spring element (not shown) or a pressing unit can provide a specific alignment of the two opposite coil units 26, 42 which is loaded by spring pressure. The storage seat 50 and/or the housing 44 of the battery unit can ensure correct positioning and alignment of the battery unit 30 in the storage seat 50 by structures of complementary shape. A touch control panel 112 for retrieving data from the battery units 30 and for retrieving and setting charging and discharging specifications and, if relevant, payment details can be arranged on a side wall of the housing 54.

FIG. 3c is a sectional illustration E-E of FIG. 3b with three received battery units 30, which are shown in a sectional view. The respective four battery cells 40 are also shown. Each battery unit 30 is pressed onto the contact surface of the coil unit 26 of the storage seats 50 by means of spring elements 46, so that an optimized inductive coupling of the coil units 26, 42 can be provided. Various power supply and extraction connections for USB low voltage, bidirectional 48V DC protective voltage interface for feeding and withdrawing 48V voltage, 800V DC high-voltage input, mains input by means of an IEC connector and Schuko-sockets for providing 230V AC mains voltage are not shown. By means of this embodiment of a battery system 10, an energy supply e.g. for a celebration in nature or for tool processing in a construction site, can be provided, but also battery units of vehicles, tools or the like can be charged, whereby maximum personal protection is given and incorrect operation is excluded.

One embodiment of the battery unit 20 (power cell) can preferably be equipped with a lithium iron phosphate or lithium ion battery cells. The LiFe cell technology impresses with its high depth of use, constant voltage during the entire use, short charging times and an optimal ratio between space consumption and performance.

The battery unit 20 (power cell) can be modularly expanded by being connected in parallel and can be integrated into an energy network of any size. When charged, a single cell can provide energy of up to 2 kWh with a cell efficiency of over 95% and an output power of up to 2.4 kW. The battery unit 20 can offer minimal self-discharge, long service life, high depth of discharge and cycle stability, and can be safely changed during operation (“hot” swappable) without an arc occurring, electrical connections having to be disconnected or connected or electrical components can be harmed due to overcurrent. Active current regulation as a function of cell voltage and cell temperature (derating) can be provided in the internal battery management system 36. The housing 44 can be designed as a metallic, closed, contactless battery cell housing that also fulfills a transport test according to UN38.3. This is because special regulations apply since 2003 for the transport of lithium rechargeable batteries. These UN transport regulations (e.g. UN 3090, UN 3480, UN 3481) were issued by the UN and apply to transport by land, water and air.

A battery holder 20 (power pack), which is mobile by means of transport rollers 58 and transport handles 56, can accommodate two, three or more battery units 20 in storage seats 50. External supply connections and operating options can be 230V socket at 50 Hz, USB output, Ql charger, or a touch pad. An amount of energy for e.g. watching TV for 20 hours, listening to the radio for 70 hours or having a refrigerator available for 24 hours can be provided. The maximum output power can be up to 3.6 kW, the amount of energy that can be stored can be up to 6 kWh.

Building on the concept of a mobile battery receiving device described above, a larger, preferably stationary, e.g. in a residential or office building arranged battery receiving device 20 (power rack) offer a plurality of storage seats 50 for receiving up to ten battery units 30 and can thus store energy up to 20 kWh, preferably fed by a photovoltaic or wind energy source, and when required provide again with an output power of up to 10.8 kW. Both the charging and the discharging of the battery units 30 are carried out by means of effective and safe induction technology. For charging such a larger battery receiving device 20 can be charged with sustainable energy sources such as photovoltaics, wind energy or also by the power supply network by 3-phase with 50 Hz or also with 48V DC or DC high voltage with 400-800V DC. Such a battery receiving device 20 can be used, for example, as an emergency power supply for computer servers or in hospitals in a cost-effective and space-saving manner.

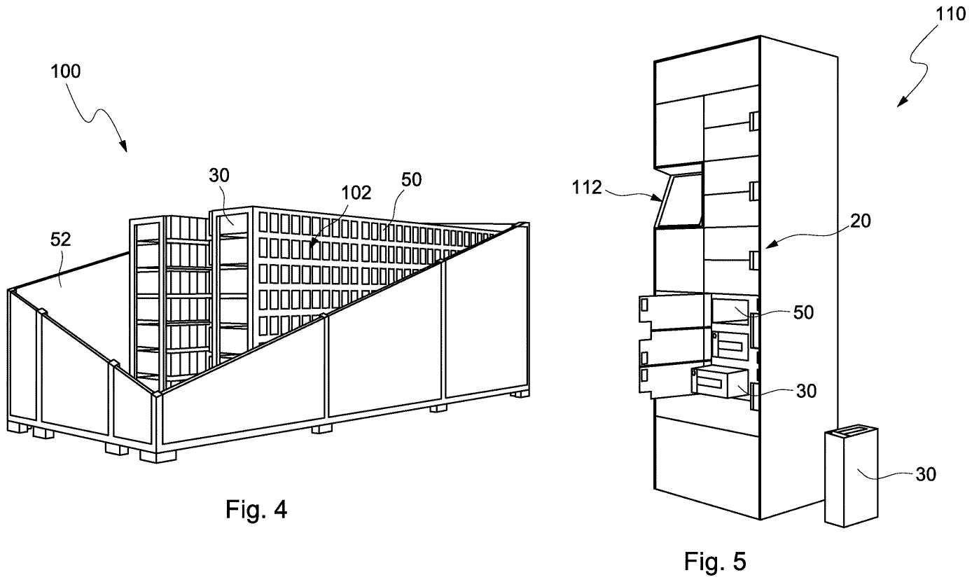

FIG. 4 shows a container battery system 100 (Mega-Rack/Power-MRack), a shelf battery receiving device 102 being arranged in a container housing, and a plurality of battery units 30 in shelf storage seats 50 of the shelf battery receiving device 102 can be arranged in parallel. These are connected to one another via an energy bus and a data bus, each storage seat 50 having a coil unit 26 and an NFC unit 28. A battery management system 52 (not shown) is connected opposite an opening side of the container for connection to an external power grid, a photovoltaic or wind energy device for power supply, in order to operate the plurality of battery units 50 in parallel and independently of one another, i.e. to be able to charge, or to be able to feed energy back into a power supply network for short to medium-term energy supply. The output power can be up to 0.75 MW and the storable total output can reach up to 1.7 MWh per container. A mains-side supply and withdrawal can be a three-phase AC with voltages between 380-480 V AC, also 48V DC or high-voltage supply with up to 800V being possible. A battery system 100 can thus provide the supply of a building or a larger network or stores energy obtained on site for later industrial use. It thus represents a modern battery system with a high degree of efficiency, wherein the capacity can be expanded modularly and is designed for high cycle efficiency. The relationship between volume, performance and reliability is suitable for high security of supply and flexible use.

FIG. 5 provides a pillar battery system 110 (power charge) with a battery receiving device 20 for a plurality of battery units 30, the individual storage seats 50 being lockable by doors. A user can control a charging or discharging process of a battery unit 30 by means of an operating panel 112 and, in particular, can control a desired amount of energy, tariffing and lending and return of a battery unit 30 for a pay charging system. The pillar battery system thus provides a concept of a public charging station that offers a convenient way of charging a battery unit 30. Stationed at frequented and barrier-free accessible urban places, the pillar battery system enables users to exchange used battery units 30 for freshly charged ones. An intuitive touchscreen display of the control panel 112 is easy to use and offers simple and cashless payment options. For example, the user can choose between suitable subscriptions or payment by credit card or smartphone. This pillar battery system 110 combines a supply and charging station for battery units 30 in a sustainable energy cycle.

### LIST OF REFERENCE SIGNS

10 battery system
20 battery unit
22 DC/DC converter on the storage seat side
24 inverter on the storage seat side
26 coil unit on the storage seat side
28 NFC unit on the storage seat side
30 battery unit
32 battery-side inverter
34 battery-side DC/DC converter
36 battery-side battery management system
38 battery-side NFC unit
40 battery cell
42 battery-side coil unit
44 battery housing
46 spring element
48 converter on the storage seat side
50 storage seat
52 battery management system on the storage seat side
54 housing of the battery holder
56 transport handle
58 transport wheels
60 coil unit
62 coil
64 ferrite core half-shell
66 ferrite element
68 contact surface
70 inference area
72 shell area
74 pressure relief valve
76 battery grip
78 NFC board area
80 coil coupling plate
82 battery cell voltage circuit
84 battery intermediate circuit
86 battery coil circuit
88 coil circuit
90 intermediate circuit
92 coil unit half-shell housing
100 container battery system
102 shelf battery holder
110 pillar battery system
112 control panel

1. A battery system comprising a battery receiving device and a plurality of battery units, wherein each battery unit can be coupled bidirectionally and inductively to one another and/or to the battery receiving device for charging and discharging, and the battery receiving device can be connected to an external electrical energy source and/or an energy sink, the each battery unit comprises a coil unit, and the battery receiving device has a storage seat for each battery unit removable with a magnetically complementary connectable coil unit for inserting and removing a battery unit without using a tool, wherein the coil unit comprises a single coil which is substantially shaped as an elliptical, elongated flat coil, arranged in a half-shell housing and embedded in a ferrite core half-shell consisting of ferrite elements, so that the coil unit has a ratio of thickness to length/width of at least 1:5, preferably 1:8, in particular 1:10 or higher, and the coil unit of the battery unit and the coil unit of the battery receiving device are formed mechanically separable with a maximum distance between the coil units of 110 mm.

2. The battery system according to claim 1, wherein at least one non-ferromagnetic coil coupling plate being arranged as a cover for the coil unit of the battery unit, in particular having ferromagnetic areas for guiding magnetic flux.

3. The battery system according to claim 1, wherein the maximum distance between the coil units is 100 mm, particularly preferably 10 mm, in particular 1 mm.

4. The battery system according to claim 1, wherein a coil winding of the coil unit consists of a high-frequency braid and the coil unit is optimized in terms of its mechanical dimensions and electromagnetic parameters for a frequency range of 50-100 kHz, in particular for an operating frequency of 70 kHz.

5. The battery system according to claim 1, wherein a near field coupling (NFC) unit is included in the coil unit.

6. The battery system according to claim 1, wherein the battery unit is mechanically closed, and has no switches or openings to the outside, and can only be charged and discharged via induction.

7. The battery system according to claim 1, wherein the battery unit and/or a storage seat of the battery receiving device comprises a mechanical and/or magnetic locking unit which enables an insertion in a correct position and/or prevents unintentional removal of the battery unit preferably in a charging and/or discharging phase.

8. The battery system according to claim 1, wherein several battery units of the plurality of battery units accommodated in a battery receiving device provide a total electrical capacity of 1.5 kWh to 1700 kWh.

9. A system complex comprising at least two or more battery systems according to claim 8, wherein the two or more battery systems are connected to form a larger system complex.

10. A battery receiving device for use in a battery system according claim 1, wherein the battery receiving device has at least one storage seat, preferably two or more storage seats with at least one magnetic complementary connectable coil unit, preferably one coil unit per storage seat for inserting and removing a battery unit toolless.

11. The battery receiving device according to claim 10, wherein a pressing unit, in particular a spring element, is arranged in a storage seat for applying a spring-loaded pressing force to the battery unit in an insertion state.

12. A battery unit for use in a battery system according to claim 1, wherein the battery unit is encapsulated in a battery housing, and including at least one, in particular a plurality of battery cells, a coil unit, a battery management system and a near field coupling (NFC) unit for an at least monodirectional, preferably bidirectional data communication.

13. The battery unit according to claim 12, wherein the coil unit and the NFC unit are structurally integrated in a front side of the battery housing which is smaller regarding areas of other side surfaces of the battery housing.

14. The battery unit according to claim 13, wherein a pressing unit, in particular a spring element, is arranged on a surface opposite the front side for applying a spring-loaded pressing force in the insertion state in a storage seat on the front side.
